(19) United States
(12) Patent Application Publication
(10) Pub. No.: US 2004/0178591 A1
(43) Pub. Date: Sep. 16, 2004

(54) Combination golf cart and carry bag

(76) Inventor: Gary A. Rockow, Scotts Valley, CA (US)

Correspondence Address: GARY A. ROCKOW, 14 COOPERS HAWK CT., SCOTTS VALLEY, CA, 95066, US

(21) Appl. No.: 10/384,830

(22) Filed: Mar. 11, 2003

(51) Int. Cl. B62B 1/00

(52) U.S. Cl. 280/47.26

(57) ABSTRACT

My combination golf cart and carry bag will allow golfers to use pull carts to transport their clubs. Using a pull cart is easier and less strenuous than carrying a golf bag. At the same time, golfers will be able to experience the convenience and advantages of a carry bag for short distances. My invention possesses a unique wheel system that can retract and deploy quickly and easily. The wheel system converts from transport mode to carry mode and back again “on the fly.”

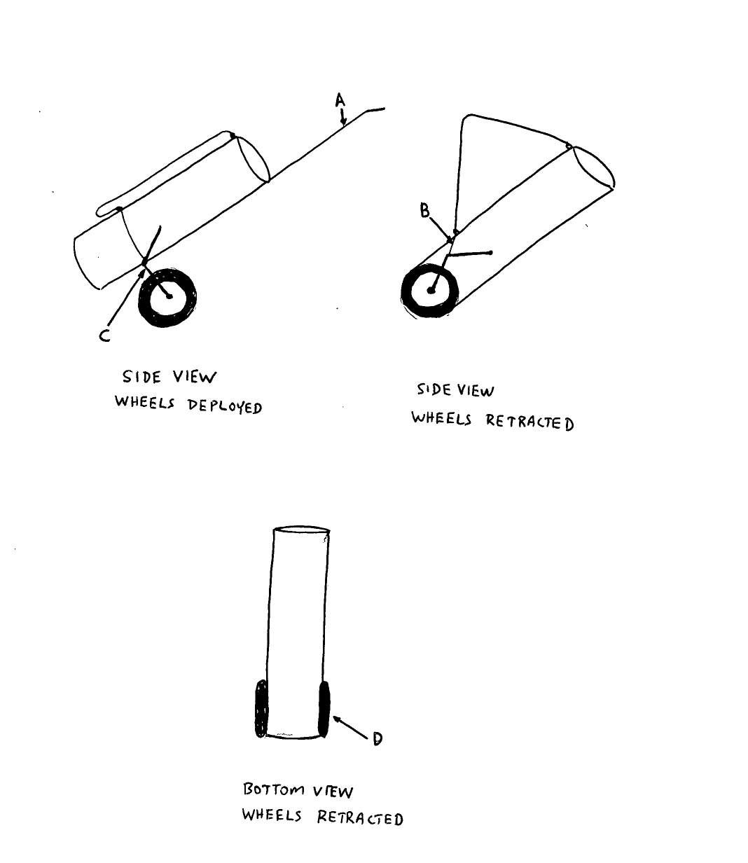

### CROSS REFERENCE TO RELATED APPLICATIONS

Patent number Patent holder

U.S. Pat. No. 2,326,482 W. C. Moffitt

U.S. Pat. No. 2,760,782 G. Hartzell

U.S. Pat. No. 2,817,538 T. S. Romang

U.S. Pat. No. 2.902,287 M. J. Elias

U.S. Pat. No. 3,900,209 McDonnell

U.S. Pat. No. 3,985,373 Widegren

U.S. Pat. No. 4,012,051 Embinder

U.S. Pat. No. 4,053,169 Taylor

U.S. Pat. No. 4,245,684 Street et al.

U.S. Pat. No. 4,822,071 Widegren

U.S. Pat. No. 4,832,362 Chen

U.S. Pat. No. 4,911,465 Hauer

U.S. Pat. No. 5,112,068 Liao et al.

U.S. Pat. No. 5,415,284 King

U.S. Pat. No. 5,435,546 Rao

U.S. Pat. No. 5,470,095 Bridges

U.S. Pat. No. 5,478,097 Forma

### BACKGROUND OF THE INVENTION

Golfers use a variety of methods to transport their clubs on a golf course. The different methods include human caddies, motorized golf carts, carry bags, pull carts, motorized pull carts, and robot caddies. The combination golf cart and carry bag is for golfers who prefer to walk when they play golf It can quickly and easily retract and deploy its wheels, allowing a golfer to switch from using a cart to roll his bag (transport mode), to carrying his bag on his shoulder for short distances (carry mode).

### BRIEF SUMMARY OF THE INVENTION

Carrying a golf bag is cumbersome and difficult. It is much easier to use a pull cart to roll golf clubs on a golf course. However, using a pull cart is not as convenient as carrying a golf bag because of certain obstacles on a golf course where pull carts are difficult to use or prohibited. For example, carrying golf clubs in a carry bag allows a golfer to negotiate rough terrain, stairs, rope lines, and putting greens. The combination golf cart and carry bag provides the best of both worlds. It quickly and easily transforms from transport mode to carry mode and back again. It allows golfers the ease of using a pull cart combined with the convenience of a carry bag for short distances. While other combination golf carts and carry bags do exist, no combination cart-bags offer the ability to transform from pull cart to carry bag and back again “on the fly”. Other combination golf carts and carry bags are designed to fold up only for storage and are not designed to be carried on the course.

The advantages of the combination golf cart and carry bag are as follows:

1) Provides an easy way for golfers to transport their clubs on wheels, reducing fatigue caused by carrying clubs for long distances.

2) Allows golfers to carry their golf clubs for short distances to negotiate obstacles where pull carts cannot be used.

### DETAILED DESCRIPTION

My invention is a combination golf cart and carry bag. When its wheels are extended and in transport mode, it performs like any other golf bag with a pull cart. What makes it unique, however, is that its wheels can retract by pulling on the carry strap, allowing the player to carry his clubs when he encounters an obstacle where a pull cart cannot be used such as stairs, rough terrain, or putting greens. Once the obstacle is successfully navigated, the wheels can be easily and quickly deployed, allowing the golfer to continue his round of golf. The carry strap on the bag is designed so when the bag is lifted into carry mode, the wheels retract and move tightly against the sides of the golf bag.

Existing combination golf cart and carry bags are not designed to be carried during a round of golf. Existing combination golf cart and carry bags have retractable wheels primarily for storage and transport to and from the golf course.

### BRIEF DESCRIPTION OF THE DRAWINGS

(A) The handle of the combination golf cart and carry bag will extend when in use and retract when not in use.

(B) When pulled, the carry strap will cause the wheels to retract and move tightly against the sides of the bag so that the golfer can carry the bag.

(C) The wheel assembly is designed to deploy into transport mode quickly and easily. The wheel legs are shaped very similar to the legs of a grasshopper.

(D) When the wheels are retracted in carry mode, they are very close to the sides of the bag.

1) I claim that my invention, the combination golf cart and carry bag, is the only golf cart and carry bag system which can quickly and easily transform from a rolling pull cart to a carry bag and back again.

2) I claim the combination golf cart and carry bag provides golfers with the option to carry their clubs for short distances over obstacles a pull cart cannot negotiate.
